(19) United States
(12) Patent Application Publication
(10) Pub. No.: US 2012/0250706 A1
(43) Pub. Date: Oct. 4, 2012

(54) TRANSVERSE LASER MODE SWITCHING

(76) Inventors: Johan Stiens, Bonheiden (BE); Werner Vandermeiren, Vilvoorde (BE)

(21) Appl. No.: 13/515,694

(22) PCT Filed: Dec. 10, 2010
(86) PCT No.: PCT/EP2010/069424

§ 371 Date: Jun. 13, 2012

(30) Foreign Application Priority Data
Dec. 14, 2009 (GB) 0921809.0

(51) Int. Cl. H01S 3/09

(52) U.S. Cl. 372/19; 372/29.011

(57) ABSTRACT

A laser (100) for outputting laser radiation includes a lasing material (110) in a resonant cavity (20) adapted for supporting a given lasing mode of oscillation. The laser (100) furthermore has at least one laser mirror (124) including a transparent portion for transmitting only a part of a beam of the laser (100) substantially smaller than the dimension of the beam of the laser (100) and the laser (100) includes a mode switching device (120) adapted to induce a change in the transmitted part of the beam, for altering the given lasing mode. A corresponding laser mirror (124), controller and a method for controlling a laser (100) also are described.

### FIELD OF THE INVENTION

The present invention relates to active medium based devices such as lasers, e.g. to methods and devices for generating laser light. More particularly, the present invention relates to methods and systems for producing laser pulses, e.g. Q-switched laser pulses, by means of transverse laser mode switching.

### BACKGROUND OF THE INVENTION

The range and importance of laser based material processing in modern manufacturing is expanding at an impressive rate across many sectors in industry and has led to an enormous variety of applications. Laser based material processing is inherently contact free. As such the problem of rapid wearing of mechanical processing tools can be drastically reduced. One of the trends in pulsed laser material processing is to use short pulses with high peak powers in order to improve the edge quality. The high laser beam intensity provided by short pulse laser technology results in the vaporization-dominated material removal rather than the melt-expulsion-dominated mechanisms using longer duration pulses. This produces less thermal and mechanical shocks, less peripheral heat flow, what leads to reduced heat affected zones (HAZ) and less burn formation and hence more precise material removal. Just as important the short pulse duration produces very high peak power. This high peak power allows the laser to process difficult materials.

When short powerful laser pulses can be provided at a high repetition rate, precision laser based material processing can be drastically speeded up. A whole series of micro-machining applications can benefit from this: drilling or perforating of numerous small holes in industrial materials without charring the edges of the material, trimming applications. Heavy industrial applications such as for example welding, scribing, slotting, surface modifications of materials, surface removal, stripping, and medical applications such as for example surgery, dental, and dermatology applications also benefit from it.

A wide range of laser resonator types have been developed and used for laser systems. Some types of optical resonators include plane parallel, confocal, concentric, or hemispherical type resonators. The resonator type is determined by the radius of curvature of the reflective mirrors defining the optical resonator cavity, and the location of each of these mirrors. For the simplest laser resonator cavity containing two reflective elements aligned to form a feedback path between them, the radius of curvature of each of these two mirrors and the spacing between the two mirrors determines the type of resonator. For example, if both mirrors are plane flat mirrors, the resonator type is called plane parallel. A hemispherical resonator consists of a flat mirror and a concave curved mirror separated by the radius of curvature of the curved mirror.

The nearly hemispherical laser resonator mode has a focus or mode waist at the flat mirror, and the mode diameter expands from this waist as the radiation propagates towards the curved mirror. Typically the output coupler, which is the laser mirror though which the radiation is emitted by the laser, is the curved mirror, and the flat mirror is highly reflective (HR). Because the laser resonator mode waist occurs at the HR flat, the power density for the circulating optical radiation is highest at the mode waist. Typically, it is advantageous to place the laser gain element at or near this mode waist, as the extraction efficiency is greatest at this location.

Q-switching is a technique which allows extremely high peak power operation of a laser. The Q-factor or quality factor of a laser is related to the losses induced in the resonator. The Q-switch operates as an intracavity shutter, and remains closed during the time which the gain element is electrically or optically pumped. By remaining closed, optical feedback is prevented and radiative losses occur only through spontaneous emission. Typically, the laser gain element is pumped for at least a time comparable to the spontaneous emission lifetime for fluorescence from the upper laser level. Therefore, losses due to spontaneous emission are minimal and the laser gain element acts as a capacitor, storing the pump energy. Once the gain element is fully “charged”, the Q-switch is opened. The intracavity flux builds up to a high peak intensity, and a high energy pulse is emitted by the Q-switched laser. Due to the Q-switching mode, the peak power can be much higher (Q-switching amplification factor values of hundred to thousand) than continuous wave (CW) power lasers, meaning that much smaller lasers can be built to produce very high optical peak powers. Smaller lasers mean lower cost of ownership. Another advantage of such compact lasers is the possibility to mount them directly on robotic arms.

There are two types of Q-switching techniques. Single-shot Q-switching refers to a technique where the pump excitation is pulsed and the Q-switch opens the optical path one time for each pump pulse; therefore, the repetition rate for the Q-switch is determined by the maximum opening rate of the Q-switch or the maximum pulse rate of the pump source, whichever is lower. A second type of Q-switching is called repetitive Q-switching. In this case, the laser gain element is pumped continuously and the Q-switch is opened at a high repetition rate. The maximum Q-switch rate is determined by the desired operating parameters. That is, once the Q-switch opening rate is faster than the inverse of the spontaneous emission lifetime of the laser gain element, then the average Q-switched power is approximately equal to the CW power that would be achieved in the absence of Q-switching.

The modulating elements for Q-switching lasers come in a great variety of forms and fashions and this for lasers in various spectral ranges, from UV till far infrared. Examples of Q-switching devices are electro-optical, acousto-optical, magneto-optical and mechanical Q-switches. Each has its advantages, disadvantages, and specific applications and is more or less developed in some or another spectral range. In all existing solutions, whatever the physical interaction principle used, the area of the modulating device is at least as big as the area of the laser beam propagating inside the cavity. It is clear that in all these cases the cost of the modulating device is a function of the area of the laser beam. In some Q-switches such as e.g. acousto-optic and mechanical devices also the rise time of the “shutter” opening and the repetition rate of the Q-switching process are determined by the diameter of the laser beam. Hence Q-switching larger lasers beams, in these cases leads to slower build-up times, hence reduced Q-switch amplification factors and smaller repletion rates, hence slower industrial processes. In other cases such as in transverse electro-optic modulators, the driving voltage of the q-switch is function of the diameter of the laser beam, one wants to Q-switch. Consequently, larger laser beams require larger driving voltages, what is often translated in higher driving costs.

Another possibility to modulate the output of the laser is by exploiting the principle of transverse laser mode switching of a laser, as e.g. described in EP2013949. In this case only a fraction of the laser beam is affected such that the induced change may cause the actually lasing mode to hop to another transverse laser mode. The new lasing mode may be an allowed lasing mode or a non-allowed lasing mode. In order to realise a pulsed output, an allowed lasing mode should be extinguished by an extinguishing means.

### SUMMARY OF THE INVENTION

It is an object of embodiments of the present invention to provide good methods and systems for providing laser light. It is an advantage of embodiments according to the present invention that good methods and systems for transverse laser mode switching as well as systems making use thereof are provided. It is an advantage of embodiments according to the present invention that by using an additional mirror with a fractional part of transparency, a modulator and/or feedback coupling means with reduced dimensions can be used. It is an advantage of embodiments according to the present invention that transverse laser mode switching systems are provided whereby existing Q-switching devices can be used without modifications for laser beams having a cross-section larger than the aperture of the Q-switching device.

It is an advantage of embodiments according to the present invention that a high output power can be obtained using fractional modulation of the beam. It is an advantage of embodiments according to the present invention that for a given aperture, the output of the laser can be increased, optimised or maximised.

The above objective is accomplished by a method and device according to the present invention.

It is an advantage of some embodiments of the present invention, that the modulating device can be cooled more efficiently as the transversal thermal path length towards the heat sink is reduced in according to the cross-sectional downscaling factor of the modulating device.

It is another advantage of embodiments of the present invention, that one can select the operation mode of the laser between switching from one transverse laser mode to another or between on/off switching, including Q-switching by selection of the mode extinguisher.

It is an advantage of embodiments of the present invention, that one can force the laser to work in a well defined transverse laser mode during the off-state of the modulator by the geometrical design of the TLMS-mirror, featuring a fractional part of transparency.

It is another advantage of embodiments of the present invention, that one can compromise between the fractional portion of the laser beam interacting with the modulation device and fractional portion interacting with the extinguisher means.

It is also an advantage of particular embodiments of the present invention that any type of Q-switching device whose switching time is dependent on the size of the laser beam, becomes faster.

It is also an advantage of particular embodiments of the present invention, that any type of Q-switching device whose repetition rate is dependent on the size of the laser beam, can allow now higher repetition rates.

It is also an advantage of particular embodiments of the present invention, that any type of Q-switching device whose driving voltage is dependent on the size of the laser beam, can allow now be driven with lower voltage pulses.

It is also an advantage of particular embodiments of the present invention, that any type of Q-switching device whose optical or electrical control power is dependent on the size of the laser beam, can allow now be driven with less power dissipation.

The present invention relates to a laser for outputting laser radiation, the laser comprising a lasing material in a resonant cavity adapted for supporting a given lasing mode of oscillation, wherein the laser furthermore comprises at least a first feedback coupling laser mirror, wherein the first feedback coupling laser mirror comprises a transparent portion for transmitting only a part of a beam of the laser substantially smaller than the dimension of the beam of the laser and the laser comprises a mode switching means adapted to induce a change in the transmitted part of the beam, for altering the given lasing mode. It is an advantage of embodiments according to the present invention that existing Q-switching devices can be used without modifications, even for laser beams with a cross-section larger than the aperture of the Q-switching device. This allows devices to be used over a larger range of beam diameter, i.e. for systems producing a larger laser beams and hence larger optical powers without modifications. Alternatively or in addition thereto, this advantage can be expressed in that smaller and hence cheaper Q-switching devices can be used or developed for a given laser beam diameter of laser beam power. It is an advantage of embodiments of the present invention, that all kinds of existing or future Q-switching operation principles, i.e. mechanical, electro-optic, acousto-optic, magneto-optic, . . . can be used.

The mode switching means may be adapted in position with respect to the first feedback coupling mirror so as to induce the change only in the transmitted part of the beam. It is an advantage of embodiments of the present invention, that the thermal impact on the modulating device is reduced due to the fact that the aperture is smaller than the actual laser beam size.

The first feedback coupling laser mirror may comprise a transparent substrate and a reflective coating applied thereto, whereby the reflective coating has been partially removed for creating the transparent portion.

The first feedback coupling laser mirror may comprise a cooling component and the reflective coating may be positioned in between the transparent substrate and the cooling component.

The transparent portion may be provided by a hole through the first feedback coupling mirror.

The first feedback coupling laser mirror may have a curvature substantially equal to the curvature of the beam front of the laser radiation at the position of the first feedback coupling mirror and obtained with the laser.

It is an advantage of embodiments according to the present invention that a mirror curvature adapted to the beam front allows reducing, minimizing and/or avoiding wavefront distortion.

The laser furthermore may comprise at least one further feedback coupling mirror defining the resonator cavity and which is exposed to the transmitted part of the first feedback coupling mirror has substantially the size of the cross-section of the part of the transmitted beam. The laser furthermore may comprise a further feedback coupling laser mirror for reflecting only the transmitted part of the beam. It is an advantage of embodiments according to the present invention that the thermal load due to laser radiation absorption at the laser mirrors can also be carried by an additional mirror. In other words, the thermal load may be spread over the further feedback coupling mirror, as well as the first feedback coupling mirror, i.e. transverse laser mode switching mirror having a fractional transparent window.

The further feedback coupling laser mirror may have substantially the size of the cross-section of the part of the transmitted beam. It is an advantage of embodiments of the present invention, that the size of the further feedback coupling laser mirror can be reduced, hence leading to a cheaper feedback coupling mirror with more compact and cheaper cooling system. The diameter of the laser may be smaller than the diameter of the laser beam at the output coupling mirror. As only a fractional part of the laser beam is propagating through the modulating device and hitting the feedback coupling mirror of the cavity, this coupling mirror can be smaller than without the insertion of the mirror in front of the modulating device with a fractional part of transparency. The curvature of these reduced feedback coupling mirrors can be equal to the curvature of larger feedback coupling mirrors.

The laser may comprise a phase adjusting means for adjusting the phase between the first feedback coupling laser mirror and any further feedback coupling laser mirror for optimizing power output and minimizing destructive interference. It is an advantage of the particular embodiments of the present invention, that output power of the laser can be maximized for a given aperture diameter of the modulating device, substantially smaller than the laser beam diameter.

The phase adjusting means may be a displacement means for adjusting the distance between the first feedback coupling mirror and any further feedback coupling laser mirror.

The phase adjusting means may be an optical element for adjusting the optical distance between the at least one laser mirror and the further laser mirror.

The laser may comprise a laser mode extinguishing means for extinguishing a given laser mode.

The laser mode extinguishing means may be integrated with the at least one laser mirror.

The laser mode extinguishing means may be integrated in an output coupling mirror for coupling radiation out of the laser.

The lasing material and the mode switching element may be positioned at different sides of the first feedback coupling mirror, whereby the lasing material may be positioned between the first feedback coupling mirror and the output coupling mirror.

The laser may comprise a main cavity defined by the output coupling mirror through which radiation is coupled out and a second feedback mirror and a subcavity defined by the output coupling mirror and the first feedback mirror, and the lasing material may be present in the subcavity whereas the mode switching element may be in the main cavity.

The present invention also relates to a laser mirror comprising a transparent portion for transmitting only a part of a beam of the laser substantially smaller than the dimension of the beam of the laser wherein the laser mirror comprises a transparent substrate and a reflective coating applied thereto. The laser mirror may comprise a cooling component, the reflective coating being positioned in between the transparent substrate and the cooling component. The laser mirror may be for use in a laser as described above.

The present invention also relates to a laser mirror for use in a laser, the laser mirror comprising a transparent portion for transmitting only a part of a beam of the laser substantially smaller than the dimension of the beam of the laser wherein transparent portion is provided by a hole through the at least one mirror.

The present invention also relates to a method for controlling a laser, the method comprising bringing the laser in a state having a given first lasing mode of oscillation, transmitting only part of the beam substantially smaller than the dimension of the beam of the laser through one of the laser mirrors and inducing a change in that part of the beam for altering the given first lasing mode.

The present invention also relates to a controller programmed for controlling a laser as described above. The controller may be programmed for optimizing the power output by controlling the optical distance between a first feedback coupling laser mirror and any further feedback coupling laser mirror of the laser.

In one aspect, the fractional interaction between the Q-switching device and the laser beam is realized by putting a reflective mirror, having a fractional portion which is transparent for the laser beam in front of the modulating device having itself an aperture at least equal or larger than the transparent portion of the reflective mirror. The size of the reflective mirror is at least larger than the size of the laser beam at that position. The curvature of that mirror is approximately equal to the curvature of the beam front at that position. The curvature of the laser beam depends at that position depends on the type of laser resonator used.

Some of the systems and methods proposed according to embodiments of the present invention enable much more cost-effective pulsed laser solutions with “near” single mode laser operation. There is a need in the market of industrial material processing for compact light modulators featuring low power dissipation together with a long lifetime for pulsed laser systems, e.g. Q-switching lasers, which improve performance and economics of existing applications. It is desirable to make the pulsed laser systems, e.g. Q-switched lasers lower in cost, more reliable than the present state of the art technologies without sacrificing Q-switching performance, and with higher peak power and shorter pulses. Embodiments described below address one or more shortcomings of modulators in various spectral windows of industrial laser processing.

Particular and preferred aspects of the invention are set out in the accompanying independent and dependent claims. Features from the dependent claims may be combined with features of the independent claims and with features of other dependent claims as appropriate and not merely as explicitly set out in the claims.

These and other aspects of the invention will be apparent from and elucidated with reference to the embodiment(s) described hereinafter.

### BRIEF DESCRIPTION OF THE DRAWINGS

FIG. 1 shows a schematic representation of an active-medium based device comprising a reflective mirror with a fractional area of transparency, feedback coupling mirror and modulating device, the latter two with reduced dimensions, according to embodiments of the present invention.

FIG. 2 shows the various transverse lasing modes of the rectangular Hermite-Gaussian type as can be used in embodiments according to the present invention.

FIG. 3 is a schematic view of a mode switch structure aligned to induce transverse mode hopping as can be used in embodiments according to the present invention.

FIG. 4a and FIG. 4b shows a schematic representation of an active-medium based device with (a) a modulating and extinguishing means positioned at the same side of the gain medium and (b) a modulating and extinguishing means positioned at opposite sides of the gain medium, according to embodiments of the present invention.

FIG. 5a, FIG. 5b, FIG. 5c show various variations on the geometry of a reflective TLMS mirror with a fractional area of transparency (a) fractional area: centred circle with reduced radius (b) fractional area: centred geometry with reduced dimensions (c) fractional area: geometry with reduced dimensions in one direction only.

FIG. 6a and FIG. 6b show the relative power of the lowest order transverse laser modes contained in (a) a centred area with growing radius and (b) a centred slit with growing width as may be obtained in embodiments according to the present invention. This applies to mirror, modulator as well as to diaphragm.

FIG. 7 shows a schematic representation of an active-medium based device comprising a reflective TLMS mirror with a fractional area of transparency and feedback coupling mirror and modulating device, the latter two with reduced dimensions and providing an extinguishing means, according to embodiments of the present invention.

FIG. 8 is a schematic view of an aperture structure aligned to extinguish the transverse mode hopping mode of operation as can be used in embodiments according to the present invention.

FIG. 9 shows a schematic representation of an active-medium based device comprising a reflective mirror with a fractional area of transparency with integrated extinguishing means and feedback coupling mirror and modulating device, the latter two with reduced dimensions, according to embodiments of the present invention.

FIG. 10a, FIG. 10b and FIG. 10c show various embodiments of a TLMS mirror with a fractional area of transparency and integrated extinguishing means, as can be used in embodiments according to the present invention.

FIG. 11a, FIG. 11b and FIG. 11c illustrate side views of different options of first feedback coupling mirrors comprising a transparent portion, according to embodiments of the present invention

FIG. 12a to FIG. 12c shows a schematic representation of active-medium based devices comprising a reflective mirror with a fractional area of transparency and feedback coupling mirror, and a control mechanism to set the optical distance between the feedback coupling mirror en the reflectivity mirror consisting according to embodiments of the present invention.

FIG. 13a and FIG. 13b shows the transverse laser modes of the resonator cavity for two distances between the feedback coupling mirror with reduced dimensions and the reflectivity mirror with fractional area of high transmissivity; (a) distance equal to a multiple of λ/2, (b) arbitrary distance between the two elements.

Table 1 indicates the maximum angular rotation to change the relative path length between 0 and λ/2 as function of the thickness of the optical window of the phase adjusting means and the minimum angle, as can be used in embodiments of the present invention.

Table 2 indicates the projection factor to be used for determining the size of the window of the phase adjusting means as function of the initial angle of incidence, as can be used in embodiments of the present invention.

The drawings are only schematic and are non-limiting. In the drawings, the size of some of the elements may be exaggerated and not drawn on scale for illustrative purposes.
Any reference signs in the claims shall not be construed as limiting the scope.
In the different drawings, the same reference signs refer to the same or analogous elements.

### DETAILED DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Devices and systems according to various embodiments as well as the making and use of the various embodiments are discussed below in detail. However, it should be appreciated that the present invention provides many applicable inventive concepts, which can be embodied in a wide variety of specific contexts. The specific embodiments discussed are merely illustrative of specific ways to make and use the invention, and do not limit the scope of the claims of the invention.

Where in embodiments reference is made to a feedback coupling mirror, reference is made to a mirror of the laser having, at its reflective portion a reflectivity close to 100% for the wavelength under consideration. Such mirror or mirrors are adapted for circulating the radiation in the laser system, i.e. not for coupling out the radiation as output of the laser system. Where in the embodiments of the present invention reference is made to an output coupling mirror, reference is made to a mirror of the laser having reflective portions with a reflectivity less than 100% in order to couple out a fraction of the circulating power defining the laser output.

Where in embodiments according to the present invention reference is made to “fractional” or “only a part of” influencing of a beam radiation, reference is made to a situation wherein spatially only a part, i.e. not over its full cross-section or not over 100% of its cross-section, of the beam radiation is influenced. In other words, reference is made to the situation wherein a beam of radiation is influenced only over part of its cross-sectional surface.

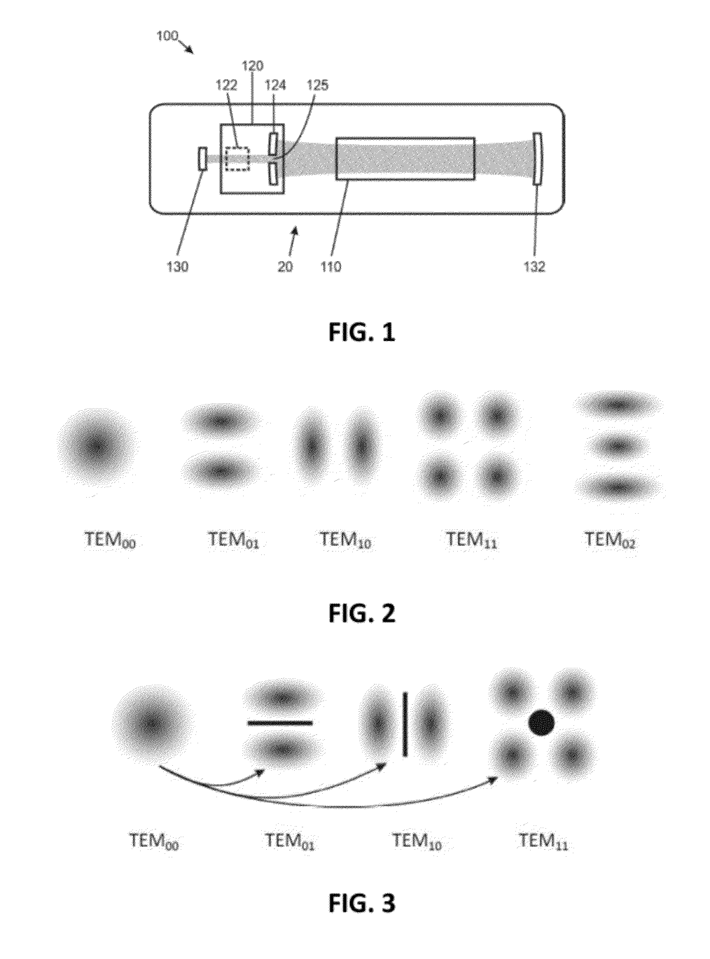

In a first aspect, the present invention relates to a laser system, also referred to as laser, for outputting laser radiation. The laser may be Q-switched, mode-locked, pulsed, etc. The laser comprises a lasing material in a resonant cavity adapted for supporting a given lasing mode of oscillation. The resonant cavity thereby may be created by laser mirrors. Typically one of the laser mirrors may be partially transparent over its full surface for coupling out laser radiation which can be used for applications using laser radiation. According to embodiments of the present invention, at least one of the laser mirrors, advantageously not the laser outcoupling mirror coupling out the radiation for application, comprises a transparent portion for transmitting only a part of a beam of the laser substantially smaller than the dimension of the beam of the laser. In other words, the transmitted portion has a cross-sectional dimension substantially smaller than the cross-sectional dimension of the laser beam in the cavity. According to embodiments of the present invention, the laser furthermore comprises a mode switching means adapted to induce a change in only the transmitted part of the beam, for altering the given lasing mode. A more detailed description of essential and optional components of the laser is described below, with reference to FIG. 1.

A laser 100, also referred to as laser system, is shown in FIG. 1. The laser is an active medium based device. The laser may be a Q-switched, mode-locked or in general pulsed laser system. The laser 100 typically may comprise a laser material or active gain material 110 in a resonant optical cavity 20 formed by lasing mirrors 124 and 132. This cavity 20 typically is tuned and aligned such that a given lasing mode, having a transverse mode pattern, would propagate when laser action is triggered.

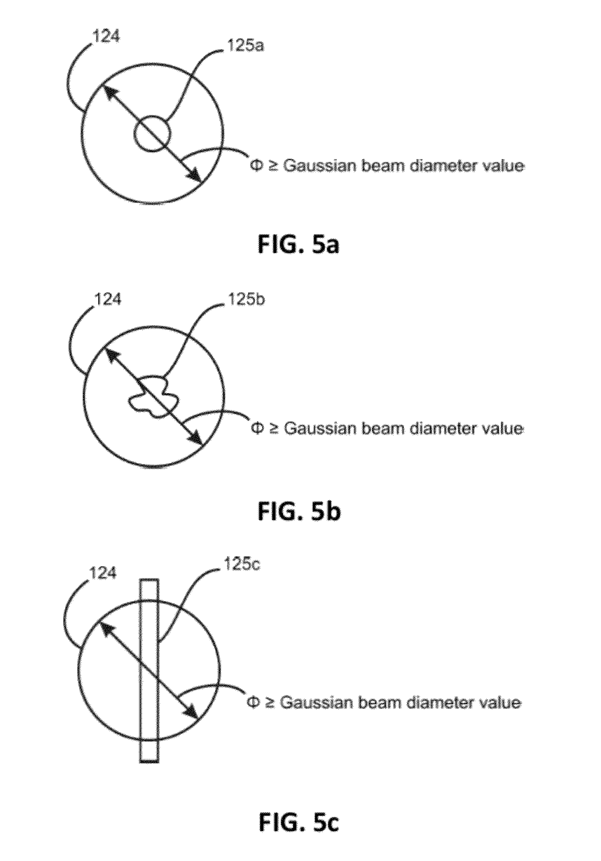

Typically the lasing mirrors 124 and 132 comprises at least a first mirror, which also may be referred to as first feedback coupling mirror 124, and a further mirror 132 being an output coupling mirror 132, through which the laser radiation is coupled out. The output coupling mirror 132 may be partially transparent over its full surface or at least the surface interacting with the full cross-section of the incident laser beam, thus allowing coupling out of the laser beam. According to embodiments of the present invention, the at least a first feedback coupling mirror 124 comprises a transparent portion 125 for transmitting only a part of the beam of the laser substantially smaller than the dimension of the beam of the laser. The dimension of the beam of the laser thereby may be the cross-section of the beam or the average diameter of such a cross-section in a direction perpendicular to the light path. As the at least one mirror 124 plays a role in the transverse laser mode switching process, it also may be referred to as the transverse laser mode switching mirror 124, i.e. a TLMS mirror. The TLMS mirror 124 features a reflective part and a transparent part 125, whereby the transparent portion 125 is substantially smaller than the dimensions of the beam of the laser. Substantially smaller than the dimensions of the beam of the laser, may be smaller than 90%, e.g. smaller than 50%, e.g. smaller than 10%, e.g. smaller than 5%, e.g. smaller than 1% or e.g. smaller than 0.1%. The specific shape of the area of the beam, e.g. of the cross-section of the beam, that is incident on the transparent portion 125 of the feedback coupling mirror 124 may be various and may be adapted to coincide with these regions of the beam comprising substantially regions where the lasing mode substantially contributes, e.g. regions with the largest intensity, although the invention is not limited thereto. The part of the beam may correspond with a localised area of a beam of the laser may be an area in the cross-section of the laser beam, i.e. an area in the cross-section taken perpendicular to the light path. The transparent portion may be adapted for transmitting a single part of the laser beam or may be adapted for transmitting different parts of the laser beam, the ensemble of different parts of the laser beam still forming a part of the laser beam substantially smaller than the dimension of the beam of the laser. The transparent portion may transmit at least 50% of the laser beam intensity of the portion of the laser beam, e.g. at least 90% of the laser beam intensity of the portion of the laser beam, e.g. at least 99% of the laser beam intensity of the portion of the laser beam, e.g. be fully transparent for the full laser beam intensity of the portion of the laser beam. The transparent portion in the first feedback coupling mirror may for example be a hole in the first feedback coupling mirror or a transparent window in the first feedback coupling mirror, as will be described in more detail later. The transparent portion may have any suitable shape allowing to select a portion of the laser beam that can usefully be modulated. The transparent portion may be a single area or may be a combination of different areas. It may be a disc shaped area, a square or rectangular area, an irregular area, it may be centered or positioned outside the center. By way of illustration, the present invention not being limited thereby, FIG. 5a, FIG. 5b and FIG. 5c show examples of various variations on the geometry of the reflective TLMS mirror 124 with a fractional area of transparency. In FIG. 5a the transparent fractional area is a centred circle (125a) with reduced radius. In FIG. 5b, the transparent fractional area is a centred geometry (125b) with reduced dimensions. In FIG. 5c the transparent fractional area has a geometry (125c) with reduced dimensions in one direction only, e.g. a rectangular shape or slit shape.

The laser mirrors furthermore typically may comprise a second feedback coupling mirror 130, for reflecting the transmitted portion of the laser beam, transmitted through the transparent portion of the first feedback coupling mirror 124. The reflection may take place after the transmitted portion of the laser beam has optionally been modulated by a mode switching means 120, as will be described in more detail below. The second feedback coupling mirror 130, advantageously can be substantially smaller than the first feedback coupling mirror 124, as it only needs to reflect the transmitted part of the laser beam. The size of the feedback coupling laser mirror 130 may thus be reduced in accordance with the size of the transparent portion of the TLMS mirror 124.

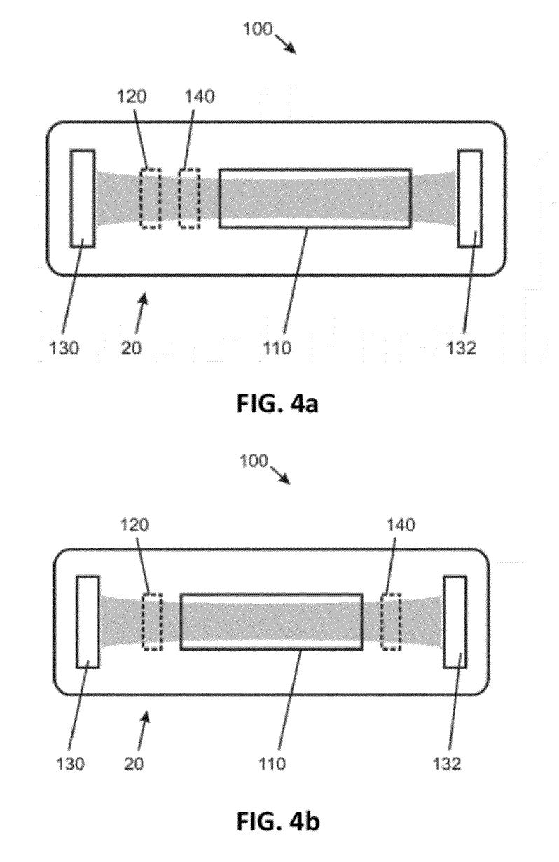

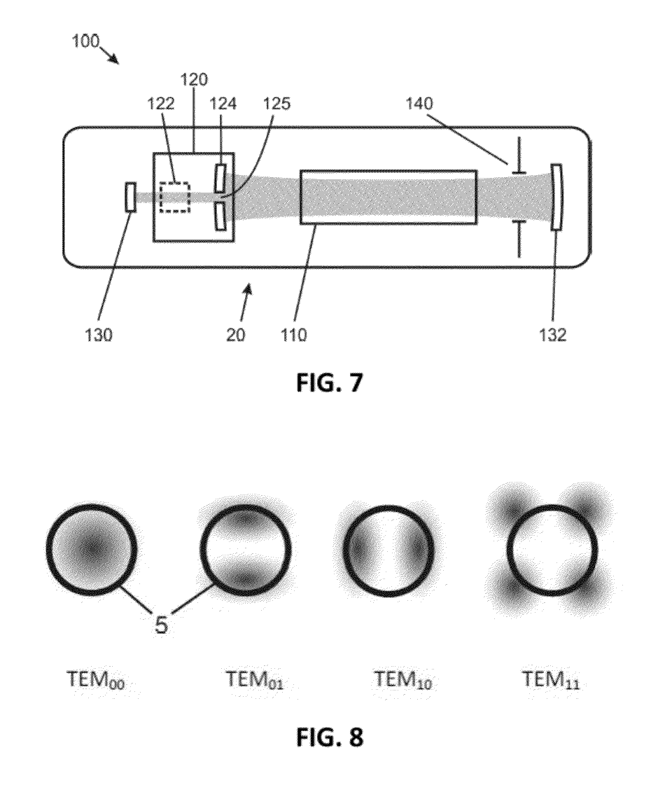

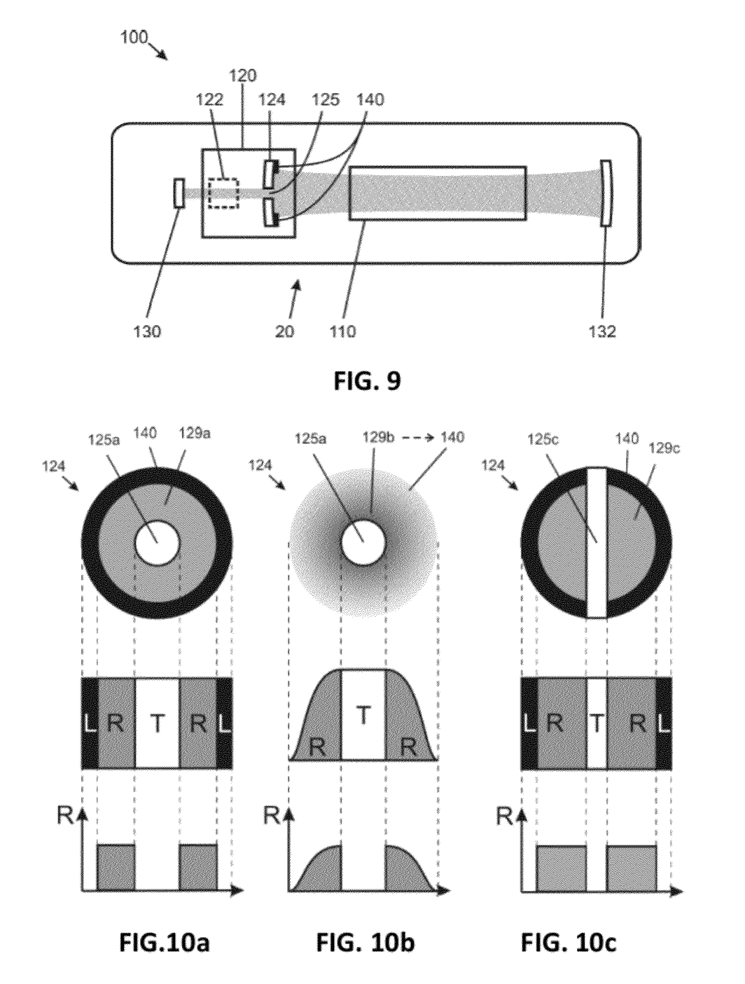

The laser furthermore comprises a mode switching means 120 adapted to induce a change in the transmitted part of the beam, for altering the given lasing mode. The mode switching means 120 may comprise an active modulator and/or a passive saturable absorber, adapted for modulating the fractional area of the laser beam exposed thereto, i.e. the fraction of the laser beam propagating through the transparent portion of the first feedback coupling mirror. It thus is sufficient for the mode switching means 120 to have cross sectional dimensions reduced with respect to the cross sectional area of the laser beam incident on the TLMS mirror 124, i.e. corresponding with the transmitted portion of the laser beam. It is an advantage of this invention as will be further discussed below for many reasons, that only a fractional area of the laser beam, hence a fractional portion of the laser beam power, is exposed to the mode switching means 120. It is an advantage of embodiments according to the present invention that a better cooling thus can be obtained of the mode switching means 120. The mode switching means therefore may comprise a cooling means, such as for example a heat sink. This fractional area is however sufficiently large to influence the given lasing mode substantially. In other words, a mode switching means 122 is used that only influences part of the beam or beam cross-section directly. The latter is performed to alter the given lasing mode, i.e. the lasing mode that typically propagates, e.g. when laser action is triggered. It may result in the lasing mode, e.g. the transverse mode pattern, to hop to a different mode pattern, e.g. a different transverse mode pattern. Typically inducing a change may comprise inducing a loss, e.g. power loss in the beam. An example of operation of the mode switching means 120 is given below, whereby after the laser has been brought in a first lasing mode, by using a mode switching means 120 adapted to influence first lasing conditions, the laser may hop to a different lasing mode, e.g. a higher transverse lasing mode. The mode switching means 120 furthermore typically may be adapted to change the lasing conditions back such that the laser system hops to the first lasing mode again. Using this mode switching allows to generate a short but intense laser pulses, as typically loss is again increased then and the laser system switches again to a different, e.g. higher transverse mode. The mode switching means 120 may therefore be or comprise e.g. an active or passive modulating device 122 that is aligned and forced into such a state that sufficient localized optical losses are induced such that the laser hops to a different mode than the first lasing mode, e.g. a higher transverse mode. This different mode, e.g. higher transverse mode, may however be brought into cut-off by an extinguishing means 140. The extinguishing means may be separate from other components or may be integrated in other components of the structure. The extinguishing means 140 could be introduced at different positions, such as for example at the same or at the opposite side of the mode switching means 120 with reference to the lasing material. FIG. 4a illustrates an active-medium based device with a modulating (120) and extinguishing means (140) positioned at the same side of the gain medium, whereas FIG. 4b illustrates an active-medium based device with a modulating (120) and extinguishing means (140) positioned at opposite sides of the gain medium. In FIG. 7 a schematic representation of an active-medium based device comprising a reflective first feedback coupling mirror 124 with a fractional area of transparence and a second feedback coupling mirror 130 and a modulating device 122. In the example shown in FIG. 7, the second feedback coupling mirror and the modulating device have reduced dimensions compared to the first feedback coupling mirror and provide an extinguishing means 140. Hence, it is possible to extinguish these higher order modes when the radius of the aperture of the diaphragm gets too small. FIG. 8 shows a view along the cavity to show the parts of the beam which would be excluded if the diaphragm has an aperture as shown, and blocks light outside the circle. The aperture structure 5 shown is aligned to extinguish the transverse mode hopping mode of operation as can be used in embodiments according to the present invention. FIG. 9 shows a schematic representation of an active-medium based device comprising a reflective mirror with a fractional area of transparency 124 with integrated extinguishing means 140, second feedback coupling mirror 130 and modulating device 122. It illustrates that the extinguishing means may be integrated. The extinguishing means for bringing the mode to which hopping is performed may operate e.g. by setting a suitable opening of a diaphragm, or e.g. by using an aperture limited (129a) or Gaussian mirror (129b). Some examples of first feedback coupling mirrors with fractional area of transparency and integrated extinguishing means 140 are shown in FIG. 10a, FIG. 10b and FIG. 10c. In FIG. 10a a front view on an apertures limited reflectivity mirror 129a with its fractional area of high transparency 125a in the centre is shown. In FIG. 10b, a front view on the reflectivity mirror 129b with a continuous fading reflectivity coefficient towards the mirror boundary and with its fractional area of high transparency in the centre is shown. In FIG. 10c, a front view on an aperture limited reflectivity mirror 129c with a rectangular area of high transparency is shown. By bringing the modulating device 122 temporarily into a state of low optical losses for a lower transverse mode pattern, the laser will output a short but intense laser pulse. The dimensions of the loss modulating means 122, also referred to as transverse mode loss switching means, e.g. Q-switching device, of this invention can be much smaller than the dimensions of the laser beam and can be positioned accordingly such that the most efficient hopping between transverse mode patterns of the laser cavity can be realized. The mode switching means 120, e.g. Q-switching device, can be based on any modulating principle such as those already well known in laser technology: AO (acoustic-optical), EO (electrical-optical), MO (magneto-optical) principles, Fabry-Perot, Mach-Zender, mechanical principles such as polygon scanners, resonant scanners, optical shutters or based on passive saturable absorbers. The mode switching means 120, which acts as an active or passive modulating device, used inside a laser cavity and if necessary fed with an appropriate steering signal, can yield a high repetition-rate short and powerful laser pulses, e.g. Q-switched laser pulses. The operating principle of the laser thus may be based on forcing mode hopping, e.g. transverse cavity mode hopping, by introducing local losses inside the laser cavity.

The overall dimensions of the transmissive part of the first feedback coupling mirror and the modulator may be matched, such that the actual size of the modulating area is optimal for required Q-switch application. In the ideal situation the modulating device introduces 100% losses due to absorption, reflection, scattering, diffraction, . . . within the fraction of the laser beam propagating through the transmissive part 125 of the first feedback coupling mirror 124. When the modulating device only partially affects that part of the laser beam propagating through the transmissive part of the first feedback coupling mirror, it is needed to increase the area such that the loss in modulation efficiency is compensated by the increased area, resulting in the same total induced losses to push the laser into higher order modes which will be extinguished by the aperture.

The laser system furthermore typically may comprise a power unit for generating driving power to bring the laser in a state of population inversion, allowing the laser system 100 to operate in a first lasing mode.

In some laser systems, e.g. some high power lasers, also may comprise additional mirrors, also referred to as folding mirrors, for guiding the laser beam to additional laser gain media.

Further optional components may be as known by the person skilled in the art from other laser systems.

According to one particular embodiment of the present invention, the radius of curvature of the reflective part of the TLMS mirror 124 coincides with the radius of curvature of the phase front of the propagating laser beam mode at the position of the mirror. The phase front of the propagating laser beam mode can be determined using known techniques, provided the laser cavity type is known, such as plane-parallel, concentric or spherical, confocal, hemi-spherical or concave-convex, . . . . The reflective part of the TLMS mirror 124 in the present embodiment is curved so that it substantially coincides with the curvature of the phase front. Additionally the minimum size of this TLMS mirror can also be calculated by any one known in the art such to be sufficient to operate as being a normal feedback coupling mirror of a laser cavity formed by this mirror and the output coupling mirror 132, at least for those portions not incident on the transparent window. The TLMS mirror 124 needs to be aligned such that lasing action in the ground mode would take place if the transparent portion of that mirror would be replaced by a reflective portion.

According to some particular embodiments, depending on the used modulating mechanism and thus depending on the used modulating device 122, the transparent window 125 of the first feedback coupling mirror 124 is adapted in shape. It can be beneficial to implement the required transparent area 125 of the first feedback coupling mirror 124 into a more square or circular shaped form or in an elongated rectangular like area, depending on the modulator used. For mechanical modulators, an elongated transparent region (a slit) is typically more beneficial as the Q-switch opening time—which determines the pulse shape and amplitude—is proportional to the width of the transparent part (dimension along the axis of the chopper blade propagation) and inversely proportional to the speed of the chopper blade. In that context, it is advantageous to minimize the width of the transparent part resulting in a rectangular shape of which the total area should be designed such that sufficient losses can be introduced by the modulation means in order to obtain transverse laser mode switching.

According to some particular embodiments, the distance between the first feedback coupling mirror 124 and the second feedback coupling mirror 130 is adapted so that a maximum output is obtained. More particularly, the distance between the first feedback coupling mirror 124 and the second feedback coupling mirror 130 may be adapted such that fully constructive interference is present for the two feedback coupling mirrors. The distance between the reflective mirror with a transparent portion and the feedback coupling mirror is by default not a multiple of λₘₐₜ/2, which results in a partially destructive interference output. By feedback controlled system this distance can be kept at a multiple of λₘₐₜ/2. Whereas partial self-compensation appears to occur in the three mirror configuration of embodiments according to the present invention, in order to guarantee full constructive interference, the positional configuration of the feedback coupling mirrors may thus be adapted. Such a correction may be done at the moment of installation of the system. Nevertheless, in order to cope with variations in the configuration or operation during operation, in preferred embodiments according to the present invention, the system may comprise a phase adjusting means so as to controllably compensate the phase difference. The phase adjusting means may be designed or configured for adapting the relative distance, i.e. optical distance, between the first feedback coupling mirror and the second feedback coupling mirror. The relative optical distance can be compensated by means of various preferred implementations. Whatever the implementation, the distance control may be manually or electronically controlled with or without an electronic feedback coupling system to adjust such that maximum laser output is guaranteed.

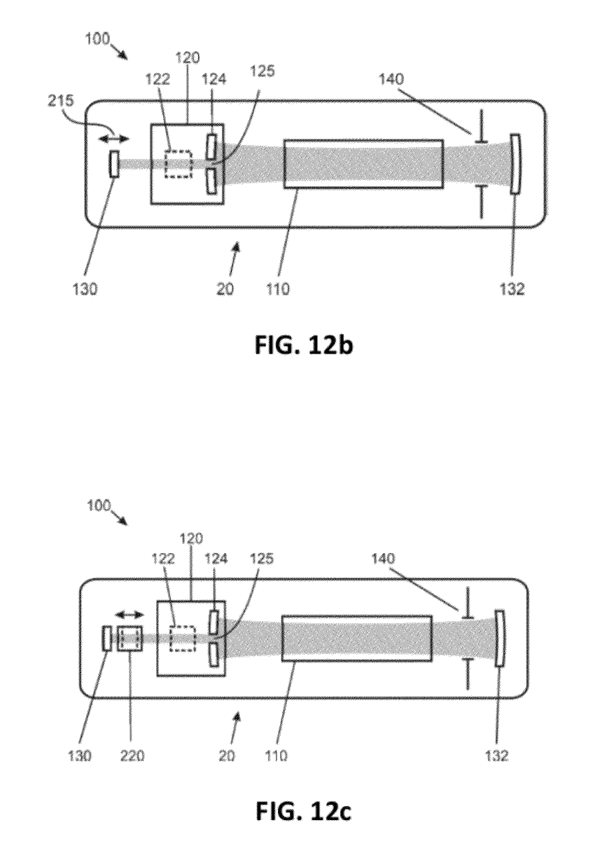

A first example comprises a translation stage coupled to the first feedback coupling mirror 124 or the second feedback coupling mirror 130 or both for controlling the distance between both mirrors, thus allowing maximizing the output of the laser as illustrated in FIG. 12b. The advantage of this implementation is that no additional optical element is added to the optical path length such that no extra optical losses are introduced.
A second example comprises the addition of an optical element between the two mirrors and which length can be adapted by e.g. the piezo-electric effect, electro-optical effects, etc, such that the optical path length between both mirrors is a multiple of λ/2 as depicted in FIG. 12c. Advantageously a piezo-electric effect can be used. This optical element is preferentially transparent and is provided by an anti-reflective coating such that the transmission is further maximized.
FIG. 12a shows a third embodiment comprising a phase adjusting means being an optical element which can rotate such that due to rotation the path length can be changed. The dependence of the path length on the angle of incidence on this optical window in this optical element is given by the following equation

$$p = \frac{d}{Cos [ Arcsin ( \frac{Sin {θ}_{air}}{{n}_{w}} ) ]}$$

wherein d is the thickness of the optical window of the phase adjusting means, n_{w} is the refractive index of the optical window material of the phase adjusting means and θₐᵢᵣ is the angle of incidence from air on the optical window of the phase adjusting means. The maximum angular rotation to change the relative path length between 0 and λ/2 is given in the table 1 and is dependent on the thickness of the optical window of the phase adjusting means and the minimum angle.

TABLE 1

| Thickness | Minimum angle | | | | |
|---|---|---|---|---|---|
| (mm) | 0 | 15 | 30 | 45 | 60 |
| 1 | 14 | 5.5 | 3 | 2 | 1.4 |
| 3 | 2.5 | 2 | 1.1 | 0.7 | 0.45 |
| 5 | 2 | 1.25 | 0.6 | 0.4 | 0.3 |

The choice of the thickness of the window material of the phase adjusting means and the minimum angular position depends on the accuracy of positioning of the rotation angle of this phase compensation optical window of the phase adjusting means. Additionally the optical window of the phase adjusting means is preferentially coated with an anti reflective coating ARC such that maximum transmission is guaranteed. As optical coatings are optimized for a given angle of incidence, it is also preferential that the angular rotation remains limited such that the ARC yields minimum reflection in the required angular rotation range. Near the Brewster angle ARC coating is even not needed when the optical window of the phase adjusting means is positioned such that a TM or p-polarised component of the laser light does not yield any reflection. Finally the choice of the initial angular position also has an impact on the required size of the window of the phase adjusting means. The window size needs to be enlarged with the calculated projection factor. This relationship is given in table 2.

TABLE 2

| Angle of | Projection |
|---|---|
| Incidence | factor |
| 0 | 1.00 |
| 15 | 1.04 |
| 30 | 1.15 |
| 45 | 1.41 |
| 60 | 2.00 |
| 75 | 3.86 |

The largest angles of incidence require the largest window sizes. When ultra-sensitive angular positioning is available, then a large equilibrium angle is preferred. One then needs a larger optical window of the phase adjusting means, but due to the very small angular change, the optical coating can be optimized for this small angular change. In applications where one prefers or is limited to lower accuracy in angular positioning, or where one needs to deal with larger mechanical vibrations or thermal expansion noise or thermally induced drift, the preferred solution is choosing an angular equilibrium position close to orthogonal to the beam, which reduces the size of the window and which reduces the dependence on mechanical fluctuations. When the size of the window of the phase adjusting means, including its price, is a crucial factor, it is preferred to put the window of the phase adjusting means such that axis of rotation is coinciding with the axis of the longest dimension of the window of the phase adjusting means, such that the projection effect applies to the smallest dimension of the part of the beam, transmitting through the transmissive window of the first feedback coupling mirror.

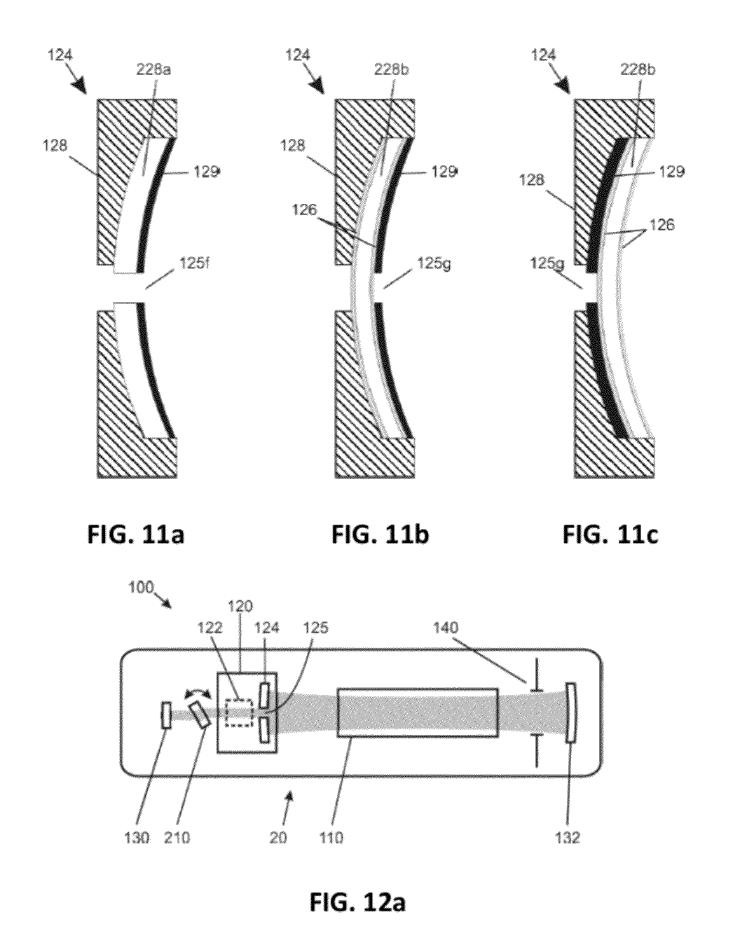

According to some particular embodiments of the present invention the transmissive portion of the first feedback coupling mirror may be a transparent optical window rather. It is an advantage of such embodiments that first feedback coupling mirrors with a transparent window can be relatively easily manufactured, compared to e.g. mirrors comprising a hole. FIG. 11a, FIG. 11b and FIG. 11c illustrate side views of different options of first feedback coupling mirrors comprising a transparent portion, being a fractional area of high transparency. All exemplary first feedback coupling mirrors are advantageously equipped with a cooling means 128 and a reflective portion in the present example being a metallic or dielectric high reflective coating. The cooling means may be a passive heat sink (e.g. based on free convection) or an active cooling device based on forced convection by means of a ventilator or water-cooling, or based on other principles such as Peltier cooling , etc. FIG. 11a illustrates a first feedback coupling mirror 124 whereby the high transparency in the centre is implemented by an air hole 125f in the curved substrate 228a. The latter has the disadvantage that it requires mechanically processing steps that have a high risk of damaging the different components of the first feedback coupling mirror. In FIGS. 11b and 11c, the curved substrate is a transparent substrate 228b, optionally provided with dielectric high anti-reflective coatings 126 at front-side and backside. The fractional area of high transparency thereby is not obtained by removing the substrate, but only by removing the reflective coating 125g from the curved substrate at the position where the transparent window needs to be. This coating can be a metallic, dielectric stack or a combination thereof by experts well known. These coatings can be etched by micro-electronic lithographic techniques, by laser ablation, or by laser drilling in order to obtain the transparent portion 125 of the TLMS-mirror 124. Whereas in FIG. 11b the reflective coating 129 is provided at the front side of the transparent substrate 228b, i.e. opposite to the side where the cooling block is present, in FIG. 11c a first feedback coupling mirror is shown whereby the reflective coating 129 is positioned at the same side as the cooling block with reference to the transparent substrate. It thereby is not only an advantage that the mechanical stability during and after manufacturing of the first feedback coupling mirror 124 is higher, it is also an advantage that creating the fractional area with high transparency induces less damage to the other components of the first feedback coupling mirror 124. It is an advantage that the backside of the TLMS mirror 124 can be cooled, except at the position on the transparent part. The cooling means 128 thereby can be organised such that they do not disturb the optical propagation path of the laser beam. A further advantage of the first feedback coupling mirror shown in FIG. 11c is that an improved cooling can be obtained as the heat transferred to the reflective layer through interaction between the incident radiation and the reflective layer can directly be transferred to the cooling block, without needing to pass the transparent substrate 228b first. It is an advantage of embodiments wherein the transparent portion is created by a transparent substrate window with a reflective coating partially removed results in an improved laser quality, as the portion of the laser beam transmitted through the first feedback coupling mirror is less disturbed. More particularly, whereas the hole in the substrate may result in diffraction at the edges of the hole over the full thickness of the substrate 228, disturbance of the transmitted beam in case of a mirror based on a transparent substrate and a partially removed reflective coating is limited to disturbance over the thickness of the reflective coating only.

In one aspect, the present invention also relates to a laser mirror for partially reflecting a laser beam, wherein the laser mirror comprises a transparent window for transmitting only a part of a beam of the laser substantially smaller than the dimension of the beam of the laser. The laser mirror thereby may be any mirror comprising standard and optionally optional components of the first feedback coupling mirror as described above for embodiments of the first aspect.

In a further aspect, the present invention also relates to a controller for controlling a laser as described in embodiments according to the first aspect of the present invention. The controller may for example be adapted for optimizing the power output by controlling the optical distance between the first feedback outcoupling mirror and the second feedback outcoupling mirror. For monitoring the power output, a detector may be present and the controller may be amended to maintain the laser significantly at maximum power output by controlling and, if required, adjusting the optical distance between the two feedback outcoupling mirrors. The controller also may be part of a system as described in the first aspect. Further optional controlling functions may be implemented providing the functionality of the steps expressed in the corresponding method.

In one aspect, the present invention also relates to a method of controlling a laser whereby the laser comprises a lasing material in a resonant optical cavity capable of supporting a given transverse mode of oscillation when lasing action is started. The method thereby comprises bringing the laser in a state having a given first lasing mode of oscillation, transmitting only part of the beam substantially smaller than the dimension of the beam of the laser through one of the laser mirrors and inducing a change in that part of the beam for altering the given first lasing mode. The laser may first be in a condition wherein no transverse lasing modes are sustained by the cavity, whereby, in embodiments for creating a laser pulse, a pulse is generated by inducing a change such that a switch is made from a situation whereby no transverse lasing modes are sustained to a situation wherein a transverse lasing mode is sustained and back, thus outputting a pulse. In other words, the original lasing mode is not sustained in the resonant optical cavity or extinguished, e.g. by introducing a loss. A change is temporary induced for altering the given first lasing mode to a second lasing mode sustained in the resonant optical cavity, thus outputting the laser pulse. The laser may also initiate with a sustained laser mode, whereby the laser is first brought, e.g. using a mode switching means, to a mode not sustained by the resonant cavity, where after a pulse is generated as described above. Further steps of method embodiments of the present invention may comprise the functionality as expressed by components of the system as described above.

In accordance with some embodiments of the invention, the invention also relates to switching between different lasing modes, e.g. different transverse lasing modes, of a laser. In this case the extinguishing means causing temporary switching, is not needed in the cavity and by switching the lasing conditions, e.g. the local optical losses induced by the mode switching means 122, the output of the laser switches to another transverse mode.

One example of a method for controlling a laser to produce laser pulses comprises providing lasing action according to a first lasing mode in a lasing material in a resonant optical cavity, temporarily inducing different lasing conditions in the cavity, causing the lasing action to hop to a different lasing mode and subsequently altering the different lasing conditions, allowing the output of a laser pulse according to the first lasing mode.

By way of illustration, the present invention not being limited thereto, the generation of pulsed laser action in embodiments according to the present invention can be for example explained based on theoretical considerations as provided below, embodiments of the present invention not being limited thereby. Suppose a system with a mode switching means comprising a loss modulating means 122 and a first feedback coupling TLMS mirror with a transparent window and second feedback coupling TLMS mirror with reduced dimensions 130, as described above. When there would be no modulating device or mode switching means inside a laser cavity, there is a competition between the different transverse modes of a laser cavity, as known from prior art. In rectangular systems, the electrical fields of these transverse cavity modes are typically the Hermite-Gaussian mode patterns described by formulas (1-4). These rectangular mode patterns are also called TEMₙₘ patterns, referring to transverse electromagnetic patterns where the index n indicates the number of zeros in the electrical field and the index m the number of zeros in the magnetic field. The n=m=0 mode is a pure Gaussian beam mode.

$$\begin{matrix}{U}_{m , n}^{HG} ( x , t , z ) = {C}_{m , n }^{HG} ( \frac{w ( o )}{w ( z )} ) \cdot exp ( - i k \frac{{x}^{2} + {y}^{2}}{2 \cdot R ( z )} ) exp ( - \frac{{x}^{2} + {y}^{2}}{{w}^{2} ( z )} ) \cdot exp ( - i \{ m + n + 1 \} ψ ) {H}_{n} ( \frac{x \sqrt{2}}{w} ) {H}_{m} ( \frac{y \sqrt{2}}{w} ) & ( 1 ) \\ ψ ( z ) = {tan}^{- 1} ( \frac{z}{{z}_{R}} ) and & ( 2 ) \\ {Z}_{R} = \frac{π {w}^{2} ( o )}{λ} & ( 3 ) \\ {C}_{m , n}^{HG} = {( \frac{2}{π n ! m !} )}^{1 / 2} {2}^{- N / 2} & ( 4 )\end{matrix}$$

x and y indicate the transverse coordinates of the laser beam, having a propagation constant k, z is the propagation direction, w(z) is the z-dependent beam waist, R(z) is the z-dependent curvature dependence, ψ(z) is the phase term, z_{R} is the Rayleigh range, λ the wavelength, Hₙ and Hₘ are Hermite polynomials of order n and m respectively and N=n+m+1. In axis-symmetric systems, the expressions for the electric fields of the laser cavity modes reduce to the typical Laguerre-Hermite polynomials. The graphical representations of the intensity distributions of rectangular mode patterns of different orders are shown in FIG. 2. When the active material 110 inside a laser cavity 20 is brought into a level of population inversion, and there are no modulation losses introduced inside a cavity, the laser is ready to lase. The order of the mode, e.g. transverse mode, emitted by the laser depends on the alignment of the elements in the laser cavity 20. For a perfect aligned laser 100, it will typically lase in its lowest order mode. When the alignment is not perfect, the laser can lase also in other modes due to competition between the various lasing modes: the lasing mode with the largest difference between gain and loss will eventually win; when the gain/loss difference values of the different modes are very close it is also possible that the lasing mode pattern is not stable and that the laser hops from one mode to the other or various modes are simultaneously lasing.

Assuming a simple linear resonator, comprising a feedback coupling mirror with reflectivity R_{f}=1 and an output coupling mirror with reflectivity R with an active gain medium of length L_{g} and excited such that its small signal gain during a single transit is gₒ. L_{g}. The gain factor Gₒ reads as:

G₀=exp└g₀·L_{g}┘ (5)

The small gain coefficient gₒ for each transverse laser mode is determined by the excitation efficiency and the pumping power of the active medium of the laser and is related to the amount of population inversion ΔN₀ and the cross-section for stimulated emission for that particular laser mode:

g₀^{mn}=ΔN₀δ₀^{mn} (6)

Taking into account the dependence of the signal gain on the intensity inside the cavity, the expression reads as:

$${G}^{mn} = exp [ {g}^{mn} \cdot {L}_{g} ] = exp [ \frac{{g}_{0}^{mn} \cdot {L}_{g}}{{( 1 + \frac{I}{{I}_{s}} )}^{\frac{1}{x}}} ] \qquad ( 7 )$$

The power factor x is related to the broadening mechanism (x=1.0 homogeneously broadened laser and x=0.5 for inhomogeneously broadened lasers).
In addition, attenuation can be split between
the attenuation in the gain medium during a single transit and described by the loss factor V₀:

V₀=exp└−α_{D}·L_{g}┘ (8)
the attenuation due to all diffraction losses in a complete return path described by the loss factor V_{d}.
   Expressing the transverse mode dependence of all these gain and loss factors the possible output power Pₒᵤₜ of any given transverse laser mode with cross sectional area A_{b} is given as follows:

$${P}_{0}^{mn} \div {A}_{b}^{mn} ( 1 - {R}^{mn} ) \cdot [ {( \frac{ln ( {G}_{0}^{mn} )}{\vert ln ( {V}_{0}^{mn} \sqrt{{R}^{mn} \cdot {V}_{d}^{mn}} ) \vert} )}^{1 / x} - 1 ] \qquad ( 9 )$$

The latter expression is valid for the case when only one of the transverse laser modes is in the cavity because all other are extinguished in one way or another.
Only these laser modes could eventually be generated for which the gain mode Gₒ(m,n) is larger than all losses. Hence one can deduce the threshold to activate a given laser mode (m,n)

ln G₀^{mn}=|ln V₀^{mn}\sqrt{R^{mn}·V_{d}^{mn}}| (10)

Assuming that the only laser mode which is lasing is the ground mode (0,0) the threshold for this mode is satisfied:

ln G₀⁰⁰=|ln V₀⁰⁰\sqrt{R⁰⁰·V_{d}⁰⁰}| (11)

By attenuating that portion of the laser beam that is transmitting through the TLMS mirror 124 centred at the axis of the laser cavity, with the modulating device 122 as indicated for example in FIG. 4, FIG. 7, FIG. 9 or FIG. 12, one can realise that the losses introduced by the modulator force that laser mode to go under threshold condition, such that it extinguishes.

ln G₀⁰⁰<|ln V₀⁰⁰\sqrt{R⁰⁰·V_{d}⁰⁰·V_{mod}⁰⁰}| (12)

ln G₀^{m≠0,n≠0}=|ln V₀^{m≠0,n≠0}\sqrt{R^{m≠0,n≠0}·V_{d}^{m≠0,n≠0}·V_{mod}^{m≠0,n≠0}}| (13)

If the cavity and gain medium allow higher order modes, the laser will hop to a higher order lasing mode because the modulation losses introduced by the modulating device will be most sensed by the TEM₀₀ mode. Due to the high losses introduced to this low order mode, the laser will hop to a higher order mode because these higher order modes have much less optical energy confined along the axis of the laser cavity. As shown by way of example in FIG. 3, if the modulation losses are substantially applied to a horizontally centred transparent part of the TLMS mirror 124, the higher transverse mode supported will be TEM₀₁ while if the localized modulation loss is applied to a vertically centred transparent part of the TLMS mirror 124, the higher transverse mode supported will be TEM₁₀. If the modulation losses are substantially applied to the centre of the beam, as shown as in FIG. 3, the higher mode supported will be the TEM₁₁ mode.

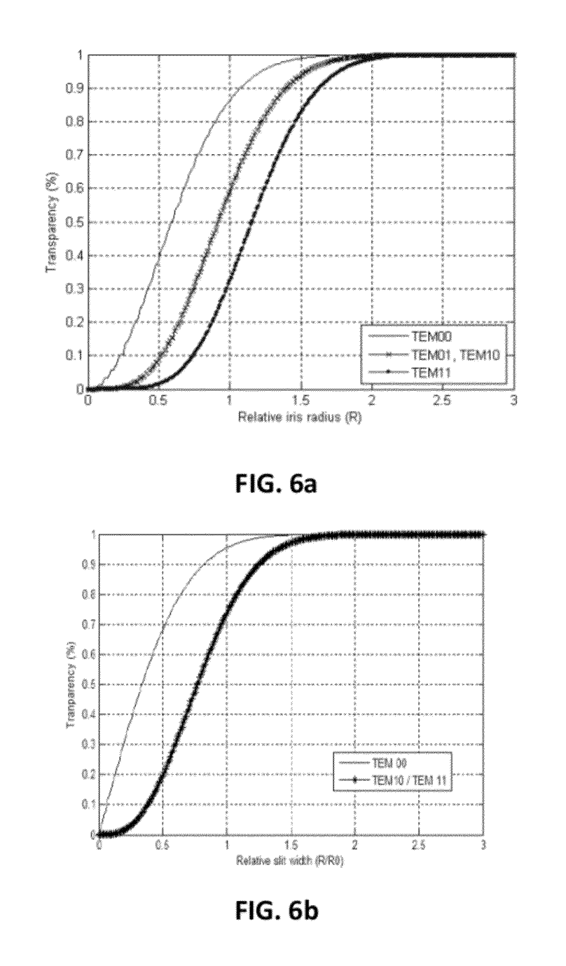

However, as described above, the resonant cavity 20 may comprise an extinguishing means 140, e.g. a diaphragm having an aperture 5 such as shown for example in FIG. 7 FIGS. 6a and 6b can be used to analyse the impact with respect to transverse mode dependent loss introduction of various components as the (TLMS-) mirrors 124, the modulating device 122 as well as the extinguishing means 140 according to embodiments of the present invention. The drawings show the relative power of the lowest order transverse laser modes contained in the transparent area. This applies to the mirror, the modulator and the diaphragm. In FIG. 6a it is shown how the transmitted power of the four lowest TEMₙₘ transverse modes are attenuated by the aperture radius of the diaphragm for a centered disc shaped area. The aperture radius is expressed in relative values with respect to the beam waist of the pure Gaussian beam TEM₀₀. The highest curve corresponds to the TEM₀₀ mode, the middle curve is valid for TEM₀₁ and TEM₁₀, the lowest curve corresponds to the TEM₁₁ mode. These curves are only valid outside the laser cavity. These graphs show us that the highest order modes are much more affected than the lower order modes. E.g. for a circular diaphragm equal to the Gaussian beam radius the TEM₀₀ mode is only for 14% attenuated whereas the TEM_{10/01} for 40% and the TEM₁₁ even for 70%. Inside the laser cavity these loss values expressed in percentages need to be added to the losses of the cavity. Assuming that a normal modulator has an aperture radius of 1.3 times the Gaussian beam radius and that the TLMS principle allows us to downscale the required radius to 0.5 times the Gaussian beam radius, an area reduction factor of ˜7 is obtained. Analogous, in FIG. 6b, it is shown how the transmitted power of the lowest TEMₙₘ transverse modes are attenuated by a vertical slit with a variable width. This width is expressed in relative values with respect to the beam waist of the pure Gaussian beam TEM₀₀. The highest curve corresponds to the TEM₀₀ mode. The second curve is valid for the TEM₁₀ and the TEM₁₁ modes as the slit width only changes along the transverse x-axis. These curves are only valid outside the laser cavity. One can notice that losses introduced by a diaphragm and slit for the TEM₀₀ with a relative radius (or width) equal to half of the Gaussian beam radius are 60% and 30%, respectively. The slit introduces lower losses that the diaphragm for equivalent width or radii as it is not restricted in one of the transverse dimensions. In other words, smaller slit widths with respect to diaphragm radii can be used for obtaining the same losses. This is an imported notice for the mechanical modulation devices as explained further.

When introducing the diaphragm with relative aperture rᵣₑₗ, an extra loss factor V_{dia}=T_{dia} (here T_{dia} is a transmission coefficient) is introduced through the diaphragm as indicated in FIG. 6a. In combination with the losses introduced by modulating device, also the higher laser modes will no longer satisfy the threshold condition:

ln G₀^{m≠0,n≠0}<|ln V₀^{m≠0,n≠0}V_{dia}^{m≠0,n≠0}\sqrt{R^{m≠0,n≠0}·V_{d}^{m≠0,n≠0}·V_{mod}^{m≠0,n≠0}}| (14)

And hence the output power of the laser will vanish, hence one has realised switching the laser between the on state and the off state.
Keeping the aperture limiting device in the given state, and switching the modulating device back to the no loss state, the threshold condition and output power read as:

$$\begin{matrix}ln {G}_{0}^{00} = \vert ln {V}_{0}^{00} {V}_{dia}^{00} \sqrt{{R}^{00} \cdot {V}_{d}^{00}} \vert & ( 15 ) \\ {P}_{0}^{00} \div {A}_{b}^{mn} ( 1 - {R}^{00} ) \cdot [ {( \frac{ln ( {G}_{0}^{00} )}{\vert ln ( {V}_{0}^{00} \cdot {V}_{dia}^{00} \sqrt{{R}^{00} \cdot {V}_{d}^{00}} ) \vert} )}^{\frac{1}{x}} - 1 ] & ( 16 )\end{matrix}$$

Hence the losses introduced by the diaphragm 140 should be small enough to allow the ground mode to lase and large enough to extinguish the higher order modes when the modulating device 122 is in its off state.

By choosing the appropriate size of the transparent part of the TLMS mirror 124 and the appropriate loss introducing area of the diaphragm 140, it is possible to switch on and off the ground mode (TEM₀₀) by switching the modulation device 122 between its no loss and high loss state without ever exciting higher order modes. The diaphragm should be set to a maximum value such that when in the on state, the laser will have a maximum power output.

In the ideal situation the TLMS mirror in combination with the modulating device and the feedback coupling mirror, will not introduce extra insertion loss with respect to the classic implementation of a switching laser by means of an intracavity modulating device with dimensions substantially larger than the laser beam cross section. It thereby may be an advantage of embodiments of the present invention that insertion losses due to anti-reflective coatings on modulating devices are even reduced with a factor equal to the area reduction factor referred to the classic, intracavity modulating device case.

In the ideal case, the modulating device introduces a 100% dynamic losses over its complete active area due to absorption, reflection, scattering, diffraction, . . . . Hence the loss factor introduced by the switching device is R_{TLMS}⁰⁰. In the theorical ideal case this latter factor is zero, such that the maximum gain allowed is almost infinity!

ln G_{0,max}⁰⁰=|ln V₀⁰⁰\sqrt{R⁰⁰·V_{d}⁰⁰·R_{TLMS}⁰⁰}| (17)

When the switching means are switched to their fully transparent state, the minimum gain reads as.

ln G_{0,min}⁰⁰=|ln V₀⁰⁰\sqrt{R⁰⁰·V_{d}⁰⁰·1}| (18)

The low signal gain setting of the laser needs to be set between these two extreme values.
Depending on the driving method of the modulator, a giant Q-switched laser pulse can be generated. This occurs when the modulator is brought sufficiently fast from the off-state into the on-state, much faster than the cavity build up time, i.e. the time it takes the circulating power to take up from noise (spontaneous emission) to a significant value. The length of this delay depends on many factors, but a very important one is the gain before the Q-switch is opened. The larger the initial gain, the less time it takes the pulse to build up. A high gain laser will produce shorter pulses. The characteristics, including peak power and pulse length of the generated Q-switch pulse are defined as follows:

$$\begin{matrix}{P}_{peak}^{00} \div \vert ln ( {R}^{00} ) \vert \cdot Δ {N}_{th}^{00} \cdot [ \frac{Δ {N}_{i}}{Δ {N}_{th}^{00}} - ln ( \frac{Δ {N}_{i}}{Δ {N}_{th}^{00}} ) - 1 ] & ( 19 ) \\ {Δτ}_{pulse} \div \frac{[ \frac{Δ {N}_{i}}{Δ {N}_{th}^{00}} - \frac{Δ {N}_{f}^{00}}{Δ {N}_{th}^{00}} ]}{\vert \frac{Δ {N}_{i}}{Δ {N}_{th}^{00}} - ln ( \frac{Δ {N}_{i}}{Δ {N}_{th}^{00}} ) - 1 \vert} & ( 20 ) \\ Δ {N}_{i}^{00} = \frac{\vert ln {V}_{0}^{00} \sqrt{{R}^{00} \cdot {V}_{d}^{00} \cdot {R}_{TLMS}^{00}} \vert}{{σ}_{0}^{00} \cdot {L}_{g}} & ( 21 ) \\ Δ {N}_{th}^{00} = \frac{\vert ln {V}_{0}^{00} \sqrt{{R}^{00} \cdot {V}_{d}^{00} \cdot 1} \vert}{{σ}_{0}^{00} \cdot {L}_{g}} & ( 22 )\end{matrix}$$

In these equations ΔNᵢ is the initial, ΔNₜₕ⁰⁰, ΔN_{f}⁰⁰ are the threshold and final population inversion densities values for the ground mode, respectively. Hence the ratio ΔNᵢ/ΔNₜₕ⁰⁰ can be further analyzed to deduce the impact of the TLMS effect.

$$\frac{Δ {N}_{i}}{Δ {N}_{th}^{00}} = \frac{\vert ln {V}_{0}^{00} \sqrt{{R}^{00} \cdot {V}_{d}^{00} \cdot {R}_{TLMS}^{00}} \vert}{\vert ln {V}_{0}^{00} \sqrt{{R}^{00} \cdot {V}_{d}^{00}} \vert} = 1 + \frac{\vert ln \sqrt{{R}_{TLMS}^{00}} \vert}{ln {V}_{0}^{00} \sqrt{{R}^{00} \cdot {V}_{d}^{00}}} \qquad ( 23 )$$

In case of no propagation neither diffraction losses a simplified expression can be obtained for this ratio.

$$\frac{Δ {N}_{i}}{Δ {N}_{th}^{00}} = \approx 1 + \frac{\vert ln \sqrt{{R}_{TLMS}^{00}} \vert}{\vert ln \sqrt{{R}^{00}} \vert} \qquad ( 24 )$$

In the ideal case for a 100% modulation efficiency the maximum peak gain will be completely determined by the maximum pump power and efficiency of the pump to determine the peak power of the Q-switched laser. In the case of the TLMS mirror with a reflecting section the output peak power is determined by the area of the reflective part and the output coupling efficiency.

$$\begin{matrix}{P}_{peak}^{00} \div \vert ln ( {R}^{00} ) \vert \cdot Δ {N}_{th}^{00} \cdot [ 1 + \frac{\vert ln \sqrt{{R}_{TLMS}^{00}} \vert}{\vert ln \sqrt{{R}^{00}} \vert} - ln ( 1 + \frac{\vert ln \sqrt{{R}_{TLMS}^{00}} \vert}{\vert ln \sqrt{{R}^{00}} \vert} ) - 1 ] & ( 25 ) \\ {g}_{0 , max}^{00} \cdot {L}_{g} = \vert ln {V}_{0}^{00} \sqrt{{R}^{00} \cdot {V}_{d}^{00} \cdot {R}_{TLMS}^{00}} \vert & ( 26 )\end{matrix}$$

Reducing the area of the transparent part 125 of the TLMS mirror 124 reduces the available peak power, under the condition that the switching speed of the modulation device is fast enough to assume that the build up of the Q-switch pulse can happen under the condition of maximum laser gain. When the switching speed of the modulating device 122 is determined by one geometrical size in the x- or y-direction, e.g. such as in the case of a transverse electro-optic effect or acousto-optic modulator, the hypothetical loss due to the area reduction of the modulating device under the condition of infinite speed can be partially compensated by the increased switching speed due to the smaller dimensions of the modulating area.

By way of illustration, the present invention not being limited thereto, the generation of standing waves and the occurrence of constructive interference conditions in a system according to embodiments of the present invention can be for example described using theoretical considerations as provided below for describing the axial mode.

In a conventional system, the standing waves inside a cavity with length L_{cav} and characterized by a refractive index n must fulfil the following boundary condition on the wavelength λₘ:

$$\frac{{λ}_{M}}{2 n} \cdot M = {L}_{cav}$$

with M: the axial mode order
Hence a periodic sequence of resonant frequencies may exist in the laser cavity:

$${f}_{M} = \frac{{c}_{o}}{{λ}_{M}} ,$$

with cₒ the speed of light.
Hence the separation between two frequencies in the laser cavity reads as follows:

$$Δ f = \vert \frac{{c}_{o}}{{λ}_{M}} - \frac{{c}_{o}}{{λ}_{M + 1}} \vert = \frac{{c}_{o}}{2 n \cdot {L}_{cav}} \vert ( M - M - 1 ) \vert = \frac{{c}_{o}}{2 n \cdot {L}_{cav}} \qquad ( 27 )$$

The frequency difference depends on the length of the cavity. Typical values for a CO₂ laser emitting at a wavelength of 10.6 μm may be as follows:
For a cavity length of 0.01 m the separation Δf is 1500 MHz and the axial mode order is about 2.10³.
For a cavity length of 1 m the separation Δf is 150 MHz and the axial mode order is about 2.10⁵.
For a cavity length of 10 m the separation Δf is 15 MHz and the axial mode order is about 2.10⁶.
For the shortest cavities, the difference in axial mode order and the frequency difference is quite large. If the spectral width of a given gain line is smaller than this frequency difference, only one laser wavelength may exist in the laser. E.g. for a CO₂ laser cavities smaller than 3 m with typically gain lines of 50 MHz wide, only one wavelength is lasing in the cavity.
The impact of a fractional increase of the laser cavity length on the spectral line of the laser is illustrated below. If one puts in equation 1 the refractive index value n=1.

$${λ}_{M} = \frac{2}{M} {L}_{cav} \to \frac{\partial {λ}_{M}}{\partial {L}_{cav}} = \frac{2}{M} .$$

For a 1 m long laser cavity

$$\frac{\partial {λ}_{M}}{\partial {L}_{cav}} \approx {10}^{- 5}$$

and thus for a cavity length change of 1 micron this leads to a wavelength change of 10⁻⁵ μm.

$${f}_{M} = \frac{c}{2 {L}_{cav}} M \frac{\partial {f}_{M}}{\partial {L}_{cav}} = - \frac{M \cdot c}{2} \frac{1}{{L}_{cav}^{2}} \qquad ( 28 )$$

for a 1 m laser cavity

$$\frac{\partial {f}_{M}}{\partial {L}_{cav}} \approx 3 \times {10}^{13} Hz \text{/} m$$

and thus for a cavity length change of 1 micron this leads to a frequency change of the order of 30 MHz.
This results in that when one induces slight changes in the laser cavity, the wavelength will change slightly within the gain line under operation such that a maximum output is still guaranteed.

Returning now to a system according to an embodiment of the present invention. An original laser cavity with length Lₒ supports a laser mode with wavelength λ_{MO} and axial number M₀.

$${M}_{0} = \frac{2 \cdot {L}_{0}}{{λ}_{M 0}} \qquad ( 29 )$$

The first feedback coupling mirror 124 is positioned at a distance I from the second feedback coupling mirror 130.

$${M}_{1} = \frac{2 \cdot ( {L}_{0} - l )}{{λ}_{M 1}} ,$$

hence the mode number for this shorter cavity is M1.
The question then is to be answered whether it is possible to find a solution where the two wavelengths are equal. A solution can be found if

$$\begin{matrix}{λ}_{M 1} = {λ}_{M 0} \to \frac{2 \cdot {L}_{0}}{{M}_{0}} = \frac{2 \cdot ( {L}_{0} - l )}{{M}_{1}} = \frac{2 \cdot ( {L}_{0} - l )}{{M}_{0} - m} & ( 30 ) \\ \to {L}_{0} ( {M}_{0} - m ) = {M}_{0} \cdot ( {L}_{0} - l ) & ( 31 ) \\ \to l = {L}_{0} \frac{m}{{M}_{0}} m , {M}_{0} ∈ N & ( 32 ) \\ or l = m \frac{{λ}_{M 0}}{2} & ( 33 )\end{matrix}$$

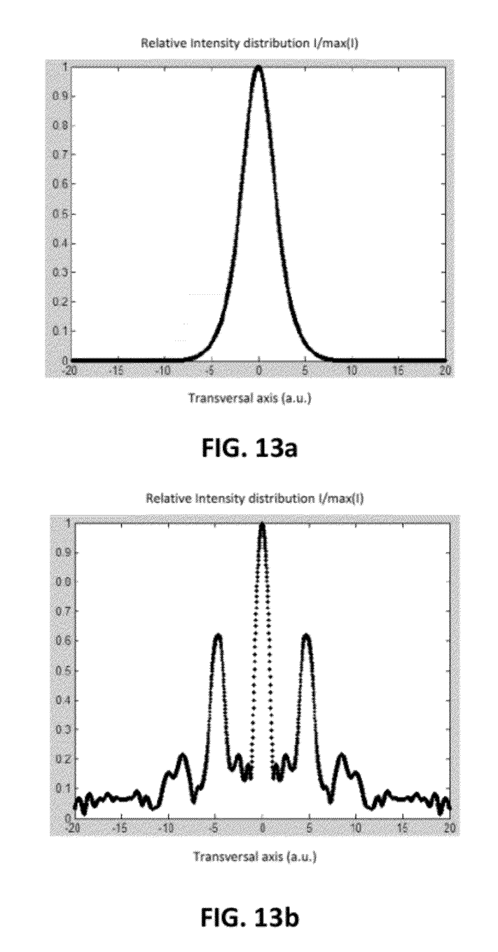

The only possible solutions are these solutions where the difference in length is a multiple of λ/2. Hence for maximum output power it is essential to have the distance between the two mirrors respected. In this perspective it looks as we need a phase compensator to obtain a fully constructive interference. If the mode would propagate slightly off-axis, we find however the same solutions. Hence the laser can never find a mode via self-adaptation with maximum output, i.e. with no destructive interference between the two mirrors. In this perspective it is benefit of this invention to provide means for optical path length compensation to obtain a fully constructive interference. Experimental work however shows that partial self-compensation appears, but not completely. Theoretically moving the distance between the two mirrors would lead to larger destructive interference effects, but this is not the case, illustrating the occurrence of partial self adaptation. However, it is preferred to reduce any destructive interference effect to a minimum. Furthermore, this destructive interference has also a negative impact on the transverse mode profile as illustrated in FIGS. 13a and 13b. FIG. 13a shows a TEM00 mode due to constructive interference and FIG. 13b shows a higher order mode as a consequence of destructive interference. Hence an extra compensation device can be used for obtaining all the time maximal constructive interference. Solutions are preferred which do not affect the impact of the existing cavity. Various solutions exist to keep the distance between the second feedback coupling mirror 130 and the first feedback coupling mirror 124 both a multiple of λ/2.
The foregoing description details certain embodiments of the invention. It will be appreciated, however, that no matter how detailed the foregoing appears in text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

1.-17. (canceled)

18. A laser for outputting laser radiation, the laser comprising a lasing material in a resonant cavity arranged to support a given lasing mode of oscillation, said laser comprising at least a first feedback coupling laser mirror comprising a transparent portion that transmits only a part of a beam of the laser that is substantially smaller than the dimension of the beam of the laser and the laser further comprises a mode switching device that induces a change in the transmitted part of the beam, thereby altering the given lasing mode.

19. The laser according to claim 18, wherein the mode switching device is configured with respect to the first feedback coupling mirror so as to induce the change only in the transmitted part of the beam.

20. The laser according to claim 18, wherein the first feedback coupling laser mirror comprises a transparent substrate and a reflective coating applied thereto, wherein the reflective coating is partially removed for creating the transparent portion.

21. The laser according to claim 20, wherein the first feedback coupling laser mirror comprises a cooling component and wherein the reflective coating is positioned in between the transparent substrate and the cooling component.

22. The laser according to claim 18, wherein the transparent portion is provided by a hole through the first feedback coupling mirror.

23. The laser according to claim 18, wherein the first feedback coupling laser mirror has a curvature substantially equal to the curvature of the beam front of the laser radiation at the position of the first feedback coupling mirror, obtained with the laser.

24. The laser according to claim 18, wherein at least one further feedback coupling mirror defining the resonator cavity and which is exposed to the transmitted part of the first feedback coupling mirror has substantially the size of the cross-section of the part of the transmitted beam.

25. The laser according to claim 18, the laser comprising a phase adjusting device that adjusts the phase between the first feedback coupling laser mirror and the further feedback coupling laser mirror for optimizing power output and minimizing destructive interference.

26. The laser according to claim 25, wherein the phase adjusting device comprises a displacement device arranged to adjust the distance between the first feedback coupling mirror and any further feedback coupling laser mirror.

27. The laser according to claim 25, wherein the phase adjusting device comprises an optical element arranged to adjust the optical distance between the first feedback coupling mirror and any further feedback coupling laser mirror.

28. The laser according to claim 18, wherein the laser comprises a laser mode extinguisher that extinguishes a given laser mode.

29. The laser according to claim 28, wherein the laser mode extinguisher is integrated with the first feedback coupling laser mirror.

30. The laser according to claim 28, wherein the laser mode extinguisher is integrated in an output coupling mirror that couples radiation out of the laser.

31. The laser according to claim 18, wherein the lasing material and the mode switching element are positioned at different sides of the first feedback coupling mirror and wherein the lasing material is positioned between the first feedback coupling mirror and an output coupling mirror.

32. The laser according to claim 18, comprising a controller that controls the laser.

33. The laser according to claim 32, wherein the controller is programmed to optimize the power output of the laser by controlling the optical distance between a first feedback coupling laser mirror and any further feedback coupling laser mirror of the laser.

34. A laser mirror for use in a laser, the laser mirror comprising a transparent portion for transmitting only a part of a beam of the laser that is substantially smaller than the dimension of the beam of the laser, wherein the laser mirror comprises a transparent substrate and a reflective coating applied thereto.

35. The laser mirror according to claim 34, wherein the laser mirror comprises a cooling component, the reflective coating being positioned in between the transparent substrate and the cooling component.

36. The laser mirror according to claim 34 in combination with a laser as recited in claim 18.

37. A method for controlling a laser, the method comprising:
bringing the laser in a state having a given first lasing mode of oscillation,
transmitting only part of the beam that is substantially smaller than the dimension of the beam of the laser through one of the laser mirrors and
inducing a change in said part of the beam to alter the given first lasing mode.
